(19) United States
(12) Patent Application Publication
(10) Pub. No.: US 2026/0268633 A1
(43) Pub. Date: Sep. 10, 2026

(54) PALM VEIN IMAGE BINARIZATION METHOD, AND PALM VEIN IDENTIFICATION METHOD AND APPARATUS

(71) Applicant: Jiangsu Top Glory Technology Co., Ltd., Suzhou (CN)

(72) Inventors: Xueshuang LI, Suzhou (CN); Lili LIN, Suzhou (CN); Guodong ZHAO, Suzhou (CN)

(73) Assignee: Jiangsu Top Glory Technology Co., Ltd., Suzhou (CN)

(21) Appl. No.: 19/633,694

(22) Filed: Mar. 30, 2026

Related U.S. Application Data
(63) Continuation of application No. PCT/CN2024/133622, filed on Nov. 21, 2024.

(30) Foreign Application Priority Data
Nov. 22, 2023 (CN) 202311558040.3

(51) Int. Cl. G06V 10/26; G06V 10/25; G06V 10/44; G06V 10/80; G06V 40/14

(52) U.S. Cl. CPC G06V 10/267; G06V 10/25; G06V 10/44; G06V 10/803; G06V 40/14

(57) ABSTRACT

A palm vein image binarization method includes: acquiring a grayscale range of a palm vein image, and dividing the palm vein image into four grayscale level regions according to the grayscale range; sequentially acquiring connected components in each grayscale level region, calculating a centroid of each connected component, and determining whether the connected components need to be fused and corrected according to the centroids of the connected components; and sequentially detecting the connected components in each grayscale level region, determining a connected component including a palm, and using a minimum grayscale value of the grayscale level region, where the connected component including the palm is located, as a binarization segmentation threshold of the palm vein image. The present disclosure can effectively solve the problem of an unsatisfactory binarization segmentation effect of palm vein images acquired in complex outdoor environments.

### CROSS-REFERENCE TO RELATED APPLICATIONS

This application is a continuation of International Patent Application No. PCT/CN2024/133622 with a filing date of Nov. 21, 2024, designating the United States, now pending, and further claims priority to Chinese Patent Application No. 2023115580403, entitled “PALM VEIN IMAGE BINARIZATION METHOD”, filed to the China National Intellectual Property Administration, on Nov. 22, 2023, which are incorporated herein by reference in their entirety.

### BACKGROUND OF THE INVENTION

### 1. Technical Field

The present disclosure relates to the technical field of biometric identification, in particular to a palm vein image binarization method, a palm vein identification method and apparatus, a device and a medium.

### 2. Description of Related Art

In a case where identity authentication is performed based on vein images, binarization segmentation needs to be performed on the vein images. Existing vein image binarization methods, such as OSTU, implement threshold classification mainly according to histograms. However, because a palm vein image is acquired in a non-contact manner, the palm is placed arbitrarily, so the acquired palm vein image possibly contains a complex background. In an outdoor environment, each object reflects light to a different degree due to non-unform irradiation, which is reflected by a plurality of different grayscale levels and a distribution similar to concentric circles in the acquired vein image, with the center being bright and the periphery being dark, thereby ultimately leading to an unsatisfactory binarization segmentation effect of the palm vein image acquired in the complex outdoor environment.

### BRIEF SUMMARY OF THE INVENTION

A main objective of the present disclosure is to provide a palm vein image binarization method, a palm vein identification method and apparatus, a device and a medium to solve the problem of an unsatisfactory binarization segmentation effect of palm vein images acquired in outdoor complex environments and improve the accuracy of identity verification based on palm vein images.

To fulfill the above objective, the present disclosure provides the following technical solutions:

In a first aspect, the present disclosure relates to a palm vein image binarization method, including:
step 1, acquiring a grayscale range of a palm vein image, and dividing the palm vein image into a first grayscale level region, a second grayscale level region, a third grayscale level region and a fourth grayscale level region according to the grayscale range;
step 2, sequentially acquiring connected components in each grayscale level region, calculating a centroid of each connected component, and determining whether the connected components need to be fused and corrected according to the centroids of the connected components; and
step 3, sequentially detecting the connected components in each grayscale level region, determining a connected component including a palm, and using a minimum grayscale value of the grayscale level region, where the connected component including the palm is located, as a binarization segmentation threshold of the palm vein image.

Optionally, the step 1 specifically includes:
step 1.1, acquiring the grayscale range of the palm vein image, that is, acquiring a maximum grayscale value maxV and a minimum grayscale value minV of the palm vein image;
step 1.2, calculating a grayscale level width range by a formula:

$$range = int ( ( max V - min V ) / 4 ) ;$$

step 1.3, dividing the palm vein image into the first grayscale level region, the second grayscale level region, the third grayscale level region and the fourth grayscale level region according to the grayscale level width range.

Optionally, a grayscale interval of the first grayscale level region is [minV, minV+range), a grayscale interval of the second grayscale level region is [minV+range, minV+range*2), a grayscale interval of the third grayscale level region is [minV+range*2, minV+range*3), and a grayscale interval of the fourth grayscale level region is [minV+range*3, maxV].

Optionally, before the step 2 is performed, the first grayscale level region is eliminated.

Optionally, the step 2 specifically includes:
step 2.1, acquiring all the connected components in the fourth grayscale level region, and sequentially calculating the centroid of each connected component;
step 2.2, acquiring all the connected components in the third grayscale level region, and sequentially calculating the centroid of each connected component; determining whether the connected components in the third grayscale level region and the connected components in the fourth grayscale level region satisfy a fusion condition according to the centroids of the connected components in the third grayscale level region and the centroids of the connected components in the fourth grayscale region; if the connected components in the third grayscale level region and the connected components in the fourth grayscale level region satisfy the fusion condition, fusing the connected components, and fusing the grayscale level regions where the connected components are located; and
step 2.3, acquiring all the connected components in the second grayscale level region, and sequentially calculating the centroid of each connected component; determining whether the connected components in the second grayscale level region and the connected components in the third grayscale level region satisfy the fusion condition according to the centroids of the connected components in the second grayscale level region and the centroids of the connected components in the third grayscale region; if the connected components in the second grayscale level region and the connected components in the third grayscale level region satisfy the fusion condition, fusing the connected components, and fusing the grayscale level regions where the connected components are located.

Optionally, the fusion condition is that if a distance between centroids of two connected components is within 10 pixels, the two connected components satisfy the fusion condition.

Optionally, the step 3 includes:
step 3.1, sequentially calculating the centroid of each connected component in each grayscale level region; and
step 3.2, with a centroid as a reference, upward traversing connected components row-by-row; determining whether a connected component including four fingers is present; if the connected component including the four fingers is present, taking the connected component as the connected component including the palm.

Optionally, in the step 3.1, the centroids of the connected components in the grayscale level regions are calculated; if a connected component formed by fusion of multiple connected components is present, a mean of the centroids of the multiple connected components is taken as a centroid of the connected component formed by fusion.

Optionally, the palm vein image binarization method further includes: correcting the binarization segmentation threshold, which specifically includes:
step 4, segmenting the palm vein image according to the binarization segmentation threshold to obtain an initial palm vein binary image, and calculating an initial area S1 of the palm in the initial palm vein binary image; and
step 5, decreasing the binarization segmentation threshold, re-segmenting the palm vein image according to the decreased binarization segmentation threshold to obtain a corrected palm vein binary image, calculating an area S2 of the palm in the corrected palm vein binary image and a position of a corrected centroid, and determining, according to S2 and the position of the corrected centroid, whether the binarization segmentation threshold needs to be further decreased.

Optionally, in the step 5, determining, according to S2 and the position of the corrected centroid, whether the binarization segmentation threshold needs to be further decreased is as follows: if S2<1.5S1 and a pixel, corresponding to the corrected centroid, in the initial palm vein binary image is located in a palm region of the initial palm vein binary image, the binarization segmentation threshold needs to be further decreased.

In a second aspect, the present disclosure further relates to a palm vein identification method, including:
step 10, acquiring a palm vein image of a target user, and calculating a binarization segmentation threshold of the palm vein image, where the binarization segmentation threshold is calculated by the palm vein image binarization method in the first aspect;
step 20, performing binarization processing on the palm vein image according to the binarization segmentation threshold to obtain a palm vein binary image;
step 30, acquiring key palm feature points of the target user according to the palm vein binary image;
step 40, acquiring a target palm region of the target user from the palm vein binary image according to the key palm feature points; and
step 50, performing identity verification on the target user according to a palm vein feature of the target palm region and a template vein feature.

Optionally, the step 40 specifically includes:
step 41, correcting the palm vein image according to the key palm feature points; and
step 42, acquiring the target palm region of the target user from the corrected palm vein image.

In a third aspect, the present disclosure further relates to a palm vein image binarization apparatus, including:
a grayscale range acquisition module, configured to acquire a grayscale range of a palm vein image and divide the palm vein image into a first grayscale level region, a second grayscale level region, a third grayscale level region and a fourth grayscale level region according to the grayscale range;
a connected component acquisition module, configured to sequentially acquire connected components in each grayscale level region, calculate a centroid of each connected component, and determine whether the connected components need to be fused and corrected according to the centroids of the connected components; and
a segmentation threshold determination module, configured to sequentially detect the connected components in each grayscale level region, determine a connected component including a palm, and use a minimum grayscale value of the grayscale level region, where the connected component including the palm is located, as a binarization segmentation threshold of the palm vein image.

In a fourth aspect, the present disclosure further relates to a palm vein identification apparatus, including:
an image acquisition module, configured to acquire a palm vein image of a target user and calculate a binarization segmentation threshold of the palm vein image, where the binarization segmentation threshold is calculated by the palm vein image binarization method in the first aspect;
a binarization module, configured to perform binarization processing on the palm vein image according to the binarization segmentation threshold to obtain a palm vein binary image;
a feature point extraction module, configured to acquire key palm feature points of the target user according to the palm vein binary image;
a target region extraction module, configured to acquire a target palm region of the target user from the palm vein binary image according to the key palm feature points; and
an identity verification module, configured to perform identity verification on the target user according to a palm vein feature of the target palm region and a template vein feature.

In a fifth aspect, the present disclosure further relates to an electronic device, including: a processor, a storage medium and a bus. The storage medium stores program instructions to be executed by the processor. When the electronic device operates, the processor communicates with the storage medium by means of the bus, and the processor executes the program instructions to perform the steps of the palm vein image binarization method in the first aspect or the steps of the palm vein identification method in the second aspect.

In a sixth aspect, the present disclosure further relates to a computer-readable storage medium, which stores a computer program. The computer program, when executed by a processor, performs the steps of the palm vein image binarization method in the first aspect or the steps of the palm vein identification method in the second aspect.

Compared with the prior art, in the present disclosure, first, an acquired palm vein image is divided into grayscale level regions; then, the grayscale level region, where a palm is located, is determined; and a minimum grayscale value of the grayscale level region is used as a segmentation threshold rather than directly determining the binarization segmentation threshold according to the entire vein image, such that the problem of an unsatisfactory binarization segmentation effect of palm vein images acquired in outdoor complex environments is effectively solved, thereby improving the accuracy of identity verification based on the palm vein images.

### BRIEF DESCRIPTION OF THE DRAWINGS

FIG. 1 is a flow diagram of a palm vein image binarization method according to the present disclosure.

FIG. 2 is a flow diagram of a palm vein identification method according to the present disclosure.

FIG. 3 is a schematic structural diagram of a palm vein image binarization apparatus according to the present disclosure.

FIG. 4 is a schematic structural diagram of a palm vein identification apparatus according to the present disclosure.

FIG. 5 is a schematic diagram of an electronic device according to the present disclosure.

### DETAILED DESCRIPTION OF PREFERRED EMBODIMENTS DISCLOSURE

To better clarify the objectives, technical solutions and advantages of the present disclosure, the present disclosure is specifically expounded below in conjunction with embodiments and accompanying drawings, but the protection scope of the present disclosure is not limited to the following embodiments.

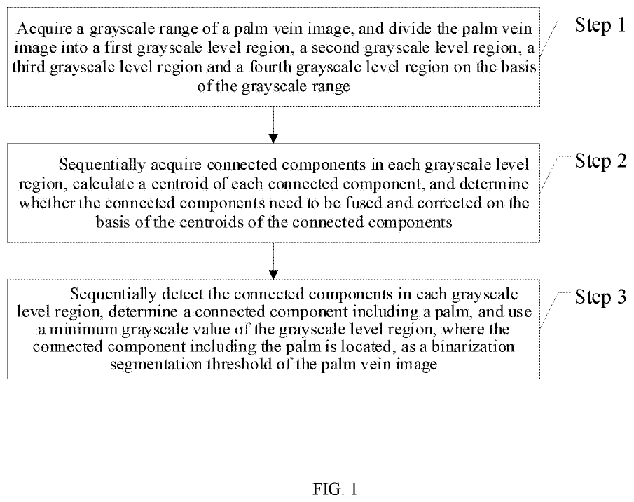

Referring to FIG. 1, the present disclosure relates to a palm vein image binarization method, including the following steps:

Step 1, a grayscale range of a palm vein image is acquired, and the palm vein image is divided into a first grayscale level region, a second grayscale level region, a third grayscale level region and a fourth grayscale level region according to the grayscale range. The step 1 includes the following specific steps:
Step 1.1, the grayscale range of the palm vein image is acquired, that is, a maximum grayscale value maxV and a minimum grayscale value minV of the palm vein image are acquired;
Step 1.2, a grayscale level width range is calculated by a formula:

$$range = int ( ( max V - min V ) / 4 ) ;$$

Step 1.3, the palm vein image is divided into the first grayscale level region, the second grayscale level region, the third grayscale level region and the fourth grayscale level region according to the grayscale level width range, where a grayscale interval of the first grayscale level region is [minV, minV+range), a grayscale interval of the second grayscale level region is [minV+range, minV+range*2), a grayscale interval of the third grayscale level region is [minV+range*2, minV+range*3), and a grayscale interval of the fourth grayscale level region is [minV+range*3, maxV].

Step 2, the first grayscale level region is eliminated, connected components in each grayscale level region are acquired sequentially, the centroid of each connected component is calculated, and whether the connected components need to be fused and corrected is determined according to the centroids of the connected components. Because the grayscale of the first grayscale level region is low, that is, the image is dark, it indicates, by a plenty of experiments, that the grayscale value of the first grayscale level region cannot be a segmentation threshold, so the first grayscale level region is eliminated here.
Step 2.1, all the connected components in the fourth grayscale level region are acquired, and the centroid of each connected component is calculated sequentially;
Step 2.2, all the connected components in the third grayscale level region are acquired, and the centroid of each connected component is calculated sequentially; whether the connected components in the third grayscale level region and the connected components in the fourth grayscale level region satisfy a fusion condition is determined according to the centroids of the connected components in the third grayscale level region and the centroids of the connected components in the fourth grayscale level region; if the connected components in the third grayscale level region and the connected components in the fourth grayscale level region satisfy the fusion condition, the connected components are fused, and the grayscale level regions, where the connected components are located, are fused; and
Step 2.3, all the connected components in the second grayscale level region are acquired, and the centroid of each connected component is calculated sequentially; whether the connected components in the second grayscale level region and the connected components in the third grayscale level region satisfy the fusion condition is determined according to the centroids of the connected components in the second grayscale level region and the centroids of the connected components in the third grayscale level region; if the connected components in the second grayscale level region and the connected components in the third grayscale level region satisfy the fusion condition, the connected components are fused, and the grayscale level regions, where the connected components are located, are fused, where if a distance between the centroids of two connected components is within 10 pixels, the two connected components satisfy the fusion condition. If the distance between the centroids of two connected components is within 10 pixels, it indicates that the two connected components are close to each other or overlapped, so the two connected components are fused to facilitate subsequent acquisition of a complete palm region.

Step 3, the connected components in each grayscale level region are detected sequentially, a connected component including a palm is determined, and a minimum grayscale value of the grayscale level region, where the connected component including the palm is located, is used as a binarization segmentation threshold of the palm vein image. The step 3 includes the following specific steps:
Step 3.1, the centroids of the connected components in each grayscale level region are calculated sequentially; if a connected component formed by fusion of multiple connected components is present, a mean of the centroids of the multiple connected components is taken as the centroid of the connected component formed by fusion; and
Step 3.2, with the centroid as a reference, all the connected components in the connected component formed by fusion are traversed upward row-by-row; whether a connected component including four fingers is present is determined; if the connected component including the four fingers is present, the connected component is taken as the connected component including the palm.

Step 4, the palm vein image is segmented according to the binarization segmentation threshold to obtain an initial palm vein binary image, and an initial area S1 of the palm in the initial palm vein binary image is calculated.

Step 5, the binarization segmentation threshold is decreased, the palm vein image is re-segmented according to the decreased binarization segmentation threshold to obtain a corrected palm vein binary image, an area S2 of the palm in the corrected palm vein binary image and the position of a corrected centroid are calculated, and whether the binarization segmentation threshold needs to be further decreased is determined according to S2 and the position of the corrected centroid. Specifically, if S2<1.5S1 and a pixel, corresponding to the corrected centroid, in the initial palm vein binary image is located in a palm region of the initial palm vein binary image, the binarization segmentation threshold needs to be further decreased.

According to the palm vein image binarization method, first, an acquired palm vein image is divided into grayscale level regions; then, the grayscale level region, where a palm is located, is determined, and a minimum grayscale value of the grayscale level region is used as a segmentation threshold rather than directly determining the binarization segmentation threshold according to the entire vein image, such that the problem of an unsatisfactory binarization segmentation effect of palm vein images acquired in outdoor complex environments is effectively solved.

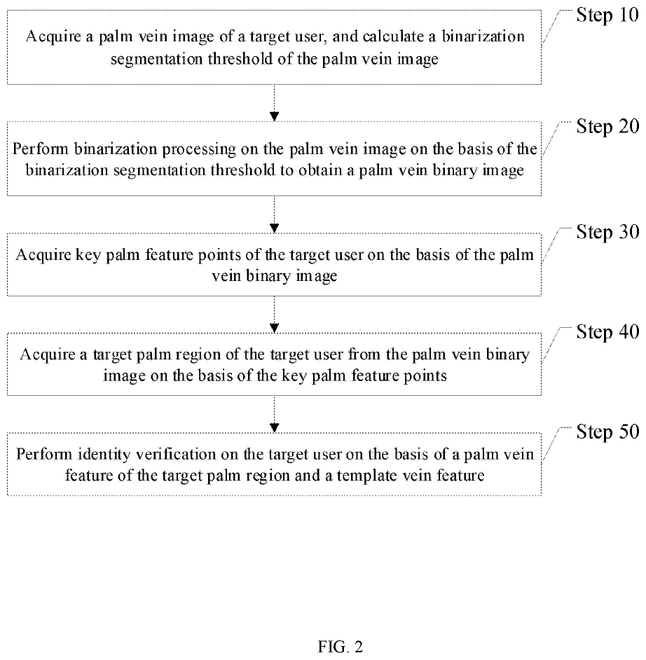

Referring to FIG. 2, the present disclosure further relates to palm vein identification method, including the following steps:
Step 10, a palm vein image of a target user is acquired, and a binarization segmentation threshold of the palm vein image is calculated, where the binarization segmentation threshold is calculated by the palm vein image binarization method mentioned above;
Step 20, binarization processing is performed on the palm vein image according to the binarization segmentation threshold to obtain a palm vein binary image;
Step 30, key palm feature points of the target user are acquired according to the palm vein binary image;
Step 40, a target palm region of the target user is acquired from the palm vein binary image according to the key palm feature points; and
Step 50, identity verification is performed on the target user according to a palm vein feature of the target palm region and a template vein feature.

In this embodiment, a preset electronic device has the function of performing identity verification on the target user according to palm veins. The preset electronic device is provided with an image acquisition module, such as a camera. The preset electronic device may be, for example, an intelligent mobile terminal, a time recorder, an access device, or the like.

The palm vein image of the target user, to be subjected to identity verification, is acquired by means of the image acquisition module, the binarization segmentation threshold of the palm vein image of the target user is obtained by the palm vein image binarization method, and binarization segmentation is performed on the palm vein image of the target user according to the binarization segmentation threshold to obtain a palm vein binary image of the target user.

Key points of the palm vein binary image are recognized to determine the key palm feature points constituting the palm of the target user, the target palm region is segmented from a corresponding position of the palm vein image according to positions of the key palm feature points in the palm vein binary image, and palm vein feature extraction is performed on the target palm region to determine the palm vein feature of the target user.

At least one template vein feature is stored in or input to the preset electronic device in advance, and a user corresponding to the template vein feature is a secure user or a trusted user. The palm vein feature extracted from the palm vein image is compared with the at least one template vein feature to determine whether a template vein feature, consistent with the palm vein feature, exists in the at least one template vein feature; if the template vein feature, consistent with the palm vein feature, exists in the at least one template vein feature, it is determined that the target user passes identity verification; if the template vein feature, consistent with the palm vein feature, does not exist in the at least one template vein feature, it is determined that target user fails to pass identity verification.

In some embodiments, each template vein feature has corresponding identity information, and if the template vein feature, consistent with the palm vein feature, exists in the at least one template vein feature, the identity information matching the template vein feature is displayed.

Optionally, the step 40 includes the following specific steps:
Step 41, the palm vein image is corrected according to the key palm feature points; and
Step 42, the target palm region of the target user is acquired from the corrected palm vein image.

In this embodiment, the palm vein image is rotated to be corrected according to the key palm feature points to ensure that the palm vein image is not tilted or skewed, and a Region of Interest (ROI) (i.e., the target palm region of the target user) is segmented from the corrected palm vein image.

The palm vein identification method has a satisfactory binarization segmentation effect on a palm vein image and performs user identity verification according to a binarization segmentation result, thereby improving the accuracy of identity verification.

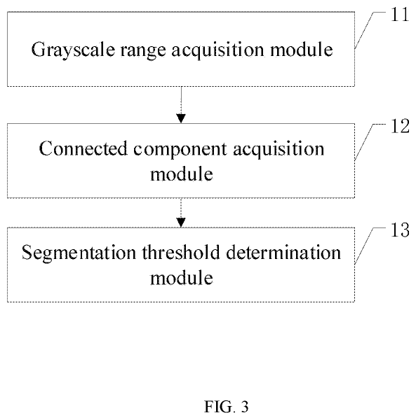

Referring to FIG. 3, the present disclosure further relates to a palm vein image binarization apparatus, including:
a grayscale range acquisition module 11, configured to acquire a grayscale range of a palm vein image and divide the palm vein image into a first grayscale level region, a second grayscale level region, a third grayscale level region and a fourth grayscale level region according to the grayscale range;
a connected component acquisition module 12, configured to sequentially acquire connected components in each grayscale level region, calculate the centroid of each connected component, and determine whether the connected components need to be fused and corrected according to the centroids of the connected components; and
a segmentation threshold determination module 13, configured to sequentially detect the connected components in each grayscale level region, determine a connected component including a palm, and use a minimum grayscale value of the grayscale level region, where the connected component including the palm is located, as a binarization segmentation threshold of the palm vein image.

Optionally, the grayscale range acquisition module 11 is specifically configured to acquire the grayscale range of the palm vein image, that is, acquire a maximum grayscale value maxV and a minimum grayscale value minV of the palm vein image; calculate a grayscale level width range by a formula: range=int((maxV−minV)/4); and divide the palm vein image into the first grayscale level region, the second grayscale level region, the third grayscale level region and the fourth grayscale level region according to the grayscale level width range.

Optionally, a grayscale interval of the first grayscale level region is [minV, minV+range), a grayscale interval of the second grayscale level region is [minV+range, minV+range*2), a grayscale interval of the third grayscale level region is [minV+range*2, minV+range*3), and a grayscale interval of the fourth grayscale level region is [minV+range*3, maxV].

Optionally, the grayscale range acquisition module 11 is also configured to eliminate the first grayscale level region.

Optionally, the connected component acquisition module 12 is specifically configured to acquire all the connected components in the fourth grayscale level region, and sequentially calculate the centroid of each connected component; acquire all the connected components in the third grayscale level region, sequentially calculate the centroid of each connected component, determine whether the connected components in the third grayscale level region and the connected components in the fourth grayscale level region satisfy a fusion condition according to the centroids of the connected components in the third grayscale level region and the centroids of the connected components in the fourth grayscale level region, and if the connected components in the third grayscale level region and the connected components in the fourth grayscale level region satisfy the fusion condition, fuse the connected components and fuse the grayscale level regions where the connected components are located; and acquire all the connected components in the second grayscale level region, sequentially calculate the centroid of each connected component, determine whether the connected components in the second grayscale level region and the connected components in the third grayscale level region satisfy the fusion condition according to the centroids of the connected components in the second grayscale level region and the centroids of the connected components in the third grayscale region, and if the connected components in the second grayscale level region and the connected components in the third grayscale level region satisfy the fusion condition, fuse the connected components and fuse the grayscale level regions where the connected components are located.

Optionally, the fusion condition is that if a distance between the centroids of two connected components is within 10 pixels, the two connected components satisfy the fusion condition.

Optionally, the segmentation threshold determination module 13 is specifically configured to sequentially calculate the centroid of each connected component in each grayscale level region; upward traverse connected components row-by-row with a centroid as a reference; determine whether a connected component including four fingers is present; and if the connected component including the four fingers is present, take the connected component as the connected component including the palm.

Optionally, the segmentation threshold determination module 13 is also configured to take, if a connected component formed by fusion of multiple connected components is present, a mean of the centroids of the multiple connected components as the centroid of the connected component formed by fusion.

Optionally, the palm vein image binarization apparatus further includes: a correction module, configured to correct the binarization segmentation threshold. The correction module is specifically configured to segment the palm vein image according to the binarization segmentation threshold to obtain an initial palm vein binary image, and calculate an initial area S1 of the palm in the initial palm vein binary image; and decrease the binarization segmentation threshold, re-segment the palm vein image according to the decreased binarization segmentation threshold to obtain a corrected palm vein binary image, calculate an area S2 of the palm in the corrected palm vein binary image and the position of a corrected centroid, and determine whether the binarization segmentation threshold needs to be further decreased according to S2 and the position of the corrected centroid.

Optionally, the correction module is also configured to further decrease the binarization segmentation threshold if S2<1.5S1 and a pixel, corresponding to the corrected centroid, in the initial palm vein binary image is located in a palm region of the initial palm vein binary image.

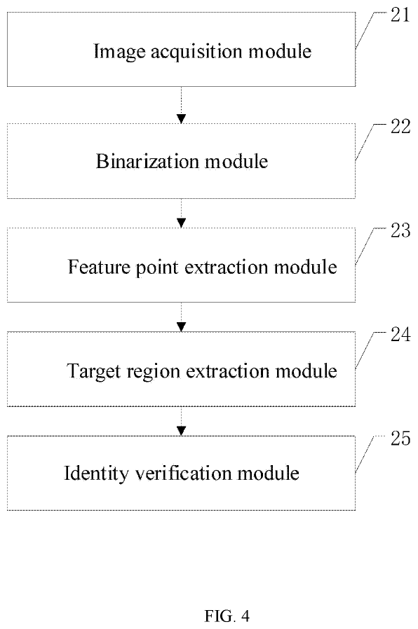

Referring to FIG. 4, the present disclosure further relates to a palm vein identification apparatus, including:
an image acquisition module 21, configured to acquire a palm vein image of a target user and calculate a binarization segmentation threshold of the palm vein image, where the binarization segmentation threshold is calculated by the palm vein image binarization method mentioned above;
a binarization module 22, configured to perform binarization processing on the palm vein image according to the binarization segmentation threshold to obtain a palm vein binary image;
a feature point extraction module 23, configured to acquire key palm feature points of the target user according to the palm vein binary image;
a target region extraction module 24, configured to acquire a target palm region of the target user from the palm vein binary image according to the key palm feature points; and
an identity verification module 25, configured to perform identity verification on the target user according to a palm vein feature of the target palm region and a template vein feature.

Optionally, the target region extraction module 24 is specifically configured to correct the palm vein image according to the key palm feature points and acquire the target palm region of the target user from the corrected palm vein image.

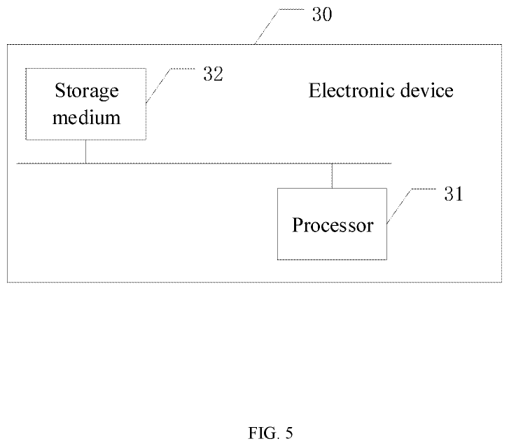

Referring to FIG. 5, the present disclosure further relates to an electronic device. The electronic device 30 includes: a processor 31, a storage medium 32 and a bus. The storage medium 32 stores program instructions to be executed by the processor 31. When the electronic device 30 operates, the processor 31 communicates with the storage medium 32 by means of the bus, and the processor 31 executes the program instructions to perform the steps of the palm vein image binarization method mentioned above or the steps of the palm vein identification method mentioned above.

In a possible implementation, the present disclosure further relates to a computer-readable storage medium. The storage medium stores a computer program. The computer program, when executed by a processor, performs the steps of the palm vein image binarization method mentioned above or the steps of the palm vein identification method mentioned above.

The above embodiments are merely used for describing preferred implementations of the present disclosure and are not intended to limit the scope of the present disclosure. Various transformations and improvements of the technical solutions of the present disclosure made by those ordinarily skilled in the art without departing from the design spirit of the present disclosure should also fall within the protection scope defined by the claims of the present disclosure.

### INDUSTRIAL APPLICABILITY

By adopting the above technical solutions, first, an acquired palm vein image is divided into grayscale level regions; then, the grayscale level region, where a palm is located, is determined, and a minimum grayscale value of the grayscale level region is used as a segmentation threshold rather than directly determining the binarization segmentation threshold according to the entire vein image, such that the problem of an unsatisfactory binarization segmentation effect of palm vein images acquired in outdoor complex environments is effectively solved, thereby improving the accuracy of identity verification based on the palm vein images.

What is claimed is:

1. A palm vein image binarization method, comprising:
step 1, acquiring a grayscale range of a palm vein image, and dividing the palm vein image into a first grayscale level region, a second grayscale level region, a third grayscale level region and a fourth grayscale level region according to the grayscale range;
step 2, sequentially acquiring connected components in each grayscale level region, calculating a centroid of each connected component, and determining whether the connected components need to be fused and corrected according to centroids of the connected components; and
step 3, sequentially detecting the connected components in each grayscale level region, determining a connected component comprising a palm, and using a minimum grayscale value of the grayscale level region where the connected component comprising the palm is located, as a binarization segmentation threshold of the palm vein image.

2. The palm vein image binarization method according to claim 1, wherein the step 1 specifically comprises:
step 1.1, acquiring the grayscale range of the palm vein image comprising acquiring a maximum grayscale value maxV and a minimum grayscale value minV of the palm vein image;
step 1.2, calculating a grayscale level width range by a formula:
$$range = int ( ( max V - min V ) / 4 ) ;$$
step 1.3, dividing the palm vein image into the first grayscale level region, the second grayscale level region, the third grayscale level region and the fourth grayscale level region according to the grayscale level width range.

3. The palm vein image binarization method according to claim 2, wherein a grayscale interval of the first grayscale level region is [minV, minV+range), a grayscale interval of the second grayscale level region is [minV+range, minV+range*2), a grayscale interval of the third grayscale level region is [minV+range*2, minV+range*3), and a grayscale interval of the fourth grayscale level region is [minV+range*3, maxV].

4. The palm vein image binarization method according to claim 1, wherein before the step 2 is performed, the first grayscale level region is eliminated.

5. The palm vein image binarization method according to claim 4, wherein the step 2 specifically comprises:
step 2.1, acquiring all the connected components in the fourth grayscale level region, and sequentially calculating a centroid of each connected component;
step 2.2, acquiring all the connected components in the third grayscale level region, and sequentially calculating the centroid of each connected component; determining whether the connected components in the third grayscale level region and the connected components in the fourth grayscale level region satisfy a fusion condition according to the centroids of the connected components in the third grayscale level region and the centroids of the connected components in the fourth grayscale region; when the connected components in the third grayscale level region and the connected components in the fourth grayscale level region satisfy the fusion condition, fusing the connected components, and fusing the grayscale level regions where the connected components are located; and
step 2.3, acquiring all the connected components in the second grayscale level region, and sequentially calculating the centroid of each connected component; determining whether the connected components in the second grayscale level region and the connected components in the third grayscale level region satisfy the fusion condition according to the centroids of the connected components in the second grayscale level region and the centroids of the connected components in the third grayscale region; when the connected components in the second grayscale level region and the connected components in the third grayscale level region satisfy the fusion condition, fusing the connected components, and fusing the grayscale level regions where the connected components are located.

6. The palm vein image binarization method according to claim 5, wherein the fusion condition is that if a distance between centroids of two connected components is within 10 pixels, the two connected components satisfy the fusion condition.

7. The palm vein image binarization method according to claim 5, wherein the step 3 comprises:
step 3.1, sequentially calculating the centroid of each connected component in each grayscale level region; and
step 3.2, with a centroid as a reference, upward traversing connected components row-by-row; determining whether a connected component comprising four fingers is present; when the connected component comprising the four fingers is present, taking the connected component as the connected component comprising the palm.

8. The palm vein image binarization method according to claim 7, wherein in the step 3.1, the centroids of the connected components in the grayscale level regions are calculated; when a connected component formed by fusion of multiple connected components is present, a mean of the centroids of the multiple connected components is taken as a centroid of the connected component formed by fusion.

9. The palm vein image binarization method according to claim 1, further comprising: correcting the binarization segmentation threshold, which specifically comprises:
step 4, segmenting the palm vein image according to the binarization segmentation threshold to obtain an initial palm vein binary image, and calculating an initial area (S1) of the palm in the initial palm vein binary image; and
step 5, decreasing the binarization segmentation threshold, re-segmenting the palm vein image according to the decreased binarization segmentation threshold to obtain a corrected palm vein binary image, calculating a corrected area (S2) of the palm in the corrected palm vein binary image and a position of a corrected centroid, and determining, according to the corrected (S2) and the position of the corrected centroid, whether the binarization segmentation threshold needs to be further decreased.

10. The palm vein image binarization method according to claim 9, wherein in the step 5, determining, according to the correct area (S2) and the position of the corrected centroid, whether the binarization segmentation threshold needs to be further decreased is as follows: when S2<1.5S1 and a pixel, corresponding to the corrected centroid, in the initial palm vein binary image is located in a palm region of the initial palm vein binary image, the binarization segmentation threshold needs to be further decreased.

11. A palm vein identification method, comprising:
step 10, acquiring a palm vein image of a target user, and calculating a binarization segmentation threshold of the palm vein image, wherein the binarization segmentation threshold is calculated by the palm vein image binarization method according to claim 1;
step 20, performing binarization processing on the palm vein image according to the binarization segmentation threshold to obtain a palm vein binary image;
step 30, acquiring key palm feature points of the target user according to the palm vein binary image;
step 40, acquiring a target palm region of the target user from the palm vein binary image according to the key palm feature points; and
step 50, performing identity verification on the target user according to a palm vein feature of the target palm region and a template vein feature.

12. The palm vein identification method according to claim 11, wherein the step 40 specifically comprises:
step 41, correcting the palm vein image according to the key palm feature points; and
step 42, acquiring the target palm region of the target user from the corrected palm vein image.

13. A palm vein identification apparatus, comprising:
an image acquisition module, configured to acquire a palm vein image of a target user and calculate a binarization segmentation threshold of the palm vein image, wherein the binarization segmentation threshold is calculated by the palm vein image binarization method according to claim 1;
a binarization module, configured to perform binarization processing on the palm vein image according to the binarization segmentation threshold to obtain a palm vein binary image;
a feature point extraction module, configured to acquire key palm feature points of the target user according to the palm vein binary image;
a target region extraction module, configured to acquire a target palm region of the target user from the palm vein binary image according to the key palm feature points; and
an identity verification module, configured to perform identity verification on the target user according to a palm vein feature of the target palm region and a template vein feature.
